(19) United States
(12) Patent Application Publication
(10) Pub. No.: US 2026/0369470 A1
(43) Pub. Date: Nov. 19, 2026

(54) INTEGRATED-YOKE BONDED MAGNET, METHOD OF MANUFACTURING SAME, ROTOR MEMBER, AND ROTATING ELECTRICAL MACHINE

(71) Applicant: Murata Manufacturing Co., Ltd., Nagaokakyo-shi (JP)

(72) Inventors: Daiki KISHIMOTO, Nagaokakyo-shi (JP); Satoshi Nagaso, Nagaokakyo-shi (JP); Ryosuke Yamamoto, Nagaokakyo-shi (JP); Takuya Nansaka, Nagaokakyo-shi (JP); Kazuyoshi Ishizuka, Nagaokakyo-shi (JP)

(21) Appl. No.: 19/725,163

(22) Filed: Jun. 30, 2026

Related U.S. Application Data
(63) Continuation of application No. PCT/JP2025/007455, filed on Mar. 3, 2025.

(30) Foreign Application Priority Data
Mar. 15, 2024 (JP) 2024-040997

(51) Int. Cl. H01F 41/02; H01F 1/053; H01F 3/08; H02K 1/14

(52) U.S. Cl. CPC H01F 41/0266; H01F 1/0533; H01F 3/08; H02K 1/146

(57) ABSTRACT

An integrated-yoke bonded magnet that includes: a yoke having an outer peripheral surface; and a bonded magnet comprising a molded hard magnetic material disposed radially outward of the yoke, the bonded magnet having an inner peripheral surface facing at least a portion of the outer peripheral surface of the yoke, wherein the outer peripheral surface of the yoke is smooth in appearance and includes microscopic irregularities in at least a facing region that faces the bonded magnet, and the inner peripheral surface of the bonded magnet includes microscopic irregularities formed by a portion of the bonded magnet interlocking with the microscopic irregularities of the outer peripheral surface of the yoke.

### CROSS REFERENCE TO RELATED APPLICATIONS

The present application is a continuation of International application No. PCT/JP2025/007455, filed Mar. 3, 2025, which claims priority to Japanese Patent Application No. 2024-040997, filed Mar. 15, 2024, the entire contents of each of which are incorporated herein by reference.

### TECHNICAL FIELD

The present disclosure relates to a technique for simplifying a manufacturing process of an integrated-yoke bonded magnet.

### BACKGROUND ART

As a conventional integrated-yoke bonded magnet, for example, an integrated-yoke bonded magnet described in Patent Document 1 is known. The integrated-yoke bonded magnet includes a cup-shaped yoke having a bottomed cylindrical shape and a cylindrical bonded magnet. The bonded magnet is arranged such that an inner peripheral surface of the bonded magnet faces an outer peripheral surface of the yoke. A central axis of the bonded magnet coincides with a central axis of the yoke. In order to prevent the bonded magnet from becoming detached from the yoke, a protrusion extending over at least a partial region in a circumferential direction is formed on an outer peripheral surface of the yoke. A plurality of notches are provided in the protrusion at equal intervals in the circumferential direction of the yoke.

Patent Document 1: Japanese Patent No. 7,279,327

### SUMMARY OF THE DISCLOSURE

In the case of the above configuration, during the manufacture of the integrated-yoke bonded magnet, it is necessary to provide a step of forming the protrusion and a plurality of the notches on the outer peripheral surface of the yoke when manufacturing the yoke. Alternatively, because the protrusion and a plurality of the notches are formed on the outer peripheral surface of the yoke, the manufacturing cost of the yoke increases.

In view of the above, an object of the present disclosure is to simplify a manufacturing process of an integrated-yoke bonded magnet.

An integrated-yoke bonded magnet according to an embodiment of the present disclosure includes: a yoke having an outer peripheral surface; and a bonded magnet comprising a molded hard magnetic material disposed radially outward of the yoke, the bonded magnet having an inner peripheral surface facing at least a portion of the outer peripheral surface of the yoke, wherein the outer peripheral surface of the yoke is smooth in appearance and includes microscopic irregularities in at least a facing region that faces the bonded magnet, and the inner peripheral surface of the bonded magnet includes microscopic irregularities formed by a portion of the bonded magnet interlocking with the microscopic irregularities of the outer peripheral surface of the yoke.

According to the integrated-yoke bonded magnet, the bonded magnet has, in at least a partial region of the inner peripheral surface facing the outer peripheral surface of the yoke, microscopic irregularities formed by a part of the bonded magnet interlocking with microscopic irregularities formed on the outer peripheral surface of the yoke. A part of the bonded magnet interlocks with the irregularities formed on the outer peripheral surface of the yoke, so that the yoke and the bonded magnet are joined together. Therefore, without providing a step of forming protrusions and a plurality of notches on the outer peripheral surface of the yoke, the integrated-yoke bonded magnet in which the yoke and the bonded magnet are joined can be obtained, and a manufacturing process of the integrated-yoke bonded magnet can be simplified.

In the integrated-yoke bonded magnet, at least a portion of the bonded magnet extends continuously from a joint surface between the outer peripheral surface of the yoke and the inner peripheral surface of the bonded magnet to an outer peripheral surface of the bonded magnet.

According to the integrated-yoke bonded magnet, at least a part of the bonded magnet is connected from the joint surface between the outer peripheral surface of the yoke and the inner peripheral surface of the bonded magnet to the outer peripheral surface of the bonded magnet, so that the yoke supports the bonded magnet from the inner peripheral surface to the outer peripheral surface thereof. As a result, the yoke and the bonded magnet are more firmly joined.

In the integrated-yoke bonded magnet, a plurality of joint surfaces are provided between the outer peripheral surface of the yoke and the inner peripheral surface of the bonded magnet.

According to the integrated-yoke bonded magnet, because there are a plurality of joint surfaces in which at least a part of the bonded magnet is connected to the outer peripheral surface of the bonded magnet, the yoke more firmly supports the bonded magnet from the inner peripheral surface to the outer peripheral surface thereof. As a result, the yoke and the bonded magnet are more firmly joined.

In the integrated-yoke bonded magnet, a maximum peak height of the outer peripheral surface of the yoke may be greater than 0 and may be less than 0.5 times an average particle diameter of the hard magnetic material. In this configuration, a maximum valley depth of the outer peripheral surface of the yoke may be greater than 0 and may be less than 0.5 times the average particle diameter of the hard magnetic material.

According to the integrated-yoke bonded magnet, the yoke and the bonded magnet are joined even if the outer peripheral surface of the yoke is not limited to having a protrusion and has no grooves.

In the integrated-yoke bonded magnet, the hard magnetic material may include a binder.

According to the integrated-yoke bonded magnet, because the hard magnetic material includes a binder, the strength of the hard magnetic material is improved. As a result, the strength of the bonded magnet is improved, and the strength of the integrated-yoke bonded magnet is improved.

The integrated-yoke bonded magnet may include resin in a gap between the outer peripheral surface of the yoke and the inner peripheral surface of the bonded magnet.

According to the integrated-yoke bonded magnet, because resin enters a gap between the outer peripheral surface of the yoke and the inner peripheral surface of the bonded magnet, the outer peripheral surface of the yoke and the inner peripheral surface of the bonded magnet are more firmly joined.

In the integrated-yoke bonded magnet, the yoke may comprise stainless steel.

According to the integrated-yoke bonded magnet, the outer peripheral surface of the yoke and the inner peripheral surface of the bonded magnet are more firmly joined.

A method of manufacturing an integrated-yoke bonded magnet according to an embodiment of the present disclosure includes: compression-molding hard magnetic powder to form a cylindrical semi-hard magnetic material; inserting a cylindrical yoke in a mold; filling the mold with the semi-hard magnetic material such that an outer peripheral surface of the yoke and an inner peripheral surface of the semi-hard magnetic material face each other; and compression-molding the yoke and the semi-hard magnetic material along an axial direction along a central axis of the yoke to form a bonded magnet having an inner peripheral surface with microscopic irregularities interlocking with microscopic irregularities of the outer peripheral surface of the yoke.

According to the above manufacturing method, the integrated-yoke bonded magnet can be easily manufactured.

The above manufacturing method may include a step of causing resin to enter a gap between the outer peripheral surface of the yoke and the inner peripheral surface of the semi-hard magnetic material after the compression molding.

According to the above manufacturing method, the resin enters the gap between the outer peripheral surface of the yoke and the inner peripheral surface of the semi-hard magnetic material, and the integrated-yoke bonded magnet in which the yoke and the bonded magnet are more firmly joined can be manufactured.

A method of manufacturing an integrated-yoke bonded magnet according to an embodiment of the present disclosure includes: inserting a cylindrical yoke in a mold, the yoke having an outer peripheral surface that is smooth in appearance and includes microscopic irregularities; filling a cavity between an outer peripheral surface of the yoke and an inner peripheral surface of the mold with a hard magnetic material; and compression-molding the yoke and the hard magnetic material along an axial direction of a central axis of the yoke to form a bonded magnet having an inner peripheral surface with microscopic irregularities interlocking with the microscopic irregularities of the outer peripheral surface of the yoke.

According to the above manufacturing method, the integrated-yoke bonded magnet can be easily manufactured.

The above manufacturing method may include, after the compression molding, a step of causing resin to enter a gap between the outer peripheral surface of the yoke and the inner peripheral surface of the bonded magnet.

According to the above manufacturing method, the resin enters the gap between the outer peripheral surface of the yoke and the inner peripheral surface of the bonded magnet, and the integrated-yoke bonded magnet in which the yoke and the bonded magnet are more firmly joined can be manufactured.

According to the present disclosure, a manufacturing process of the integrated-yoke bonded magnet can be simplified.

### BRIEF EXPLANATION OF THE DRAWINGS

FIG. 1 is an external perspective view of a brushless motor 100 in which an integrated-yoke bonded magnet 1 is used.

FIG. 2 is a schematic perspective view partially broken away to illustrate the brushless motor 100.

FIG. 3 is a perspective view of a rotor member 10.

FIG. 4 is a perspective view of a yoke 2.

FIG. 5 is a perspective view of a bonded magnet 3.

FIG. 6 is a view illustrating an example of an interface between an outer peripheral surface OS2 of the yoke 2 and an inner peripheral surface IS3 of the bonded magnet 3.

FIG. 7 is a view illustrating an example of the interface between the outer peripheral surface OS2 of the yoke 2 and the inner peripheral surface IS3 of the bonded magnet 3.

FIG. 8 is a schematic sectional view illustrating the interface between the outer peripheral surface OS2 of the yoke 2 and the inner peripheral surface IS3 of the bonded magnet 3.

FIG. 9 is a schematic sectional view illustrating an experiment for measuring bonding strength between the outer peripheral surface OS2 of the yoke 2 and the inner peripheral surface IS3 of the bonded magnet 3.

FIG. 10 is a flowchart illustrating an example of a method of manufacturing the integrated-yoke bonded magnet 1.

FIG. 11 is a sectional view illustrating an example of a manufacturing process of the integrated-yoke bonded magnet 1.

FIG. 12 is a sectional view illustrating an example of the manufacturing process of the integrated-yoke bonded magnet 1.

FIG. 13 is a sectional view illustrating an example of the manufacturing process of the integrated-yoke bonded magnet 1.

FIG. 14 is a sectional view illustrating an example of the manufacturing process of the integrated-yoke bonded magnet 1.

FIG. 15 is a flowchart illustrating an example of the method of manufacturing the integrated-yoke bonded magnet 1.

FIG. 16 is a sectional view illustrating an example of the manufacturing process of the integrated-yoke bonded magnet 1.

FIG. 17 is a sectional view illustrating an example of the manufacturing process of the integrated-yoke bonded magnet 1.

FIG. 18 is a sectional view illustrating an example of the manufacturing process of the integrated-yoke bonded magnet 1.

FIG. 19 is a perspective view of an integrated-yoke bonded magnet 1a.

FIG. 20 is a flowchart illustrating an example of a method of manufacturing the integrated-yoke bonded magnet 1a.

FIG. 21 is a sectional view illustrating an example of the method of manufacturing the integrated-yoke bonded magnet 1a.

FIG. 22 is a flowchart illustrating an example of the method of manufacturing the integrated-yoke bonded magnet 1a.

### DESCRIPTION OF THE PREFERRED EMBODIMENTS

### First Embodiment

### Configuration of Brushless Motor 100

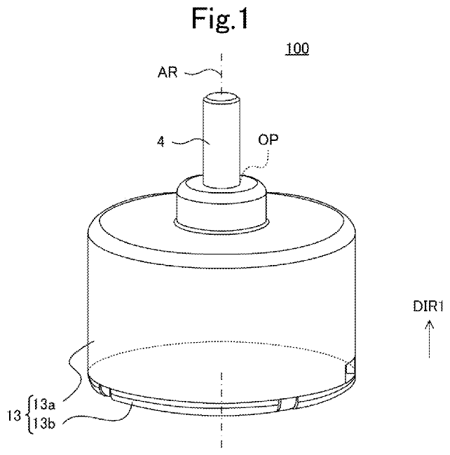

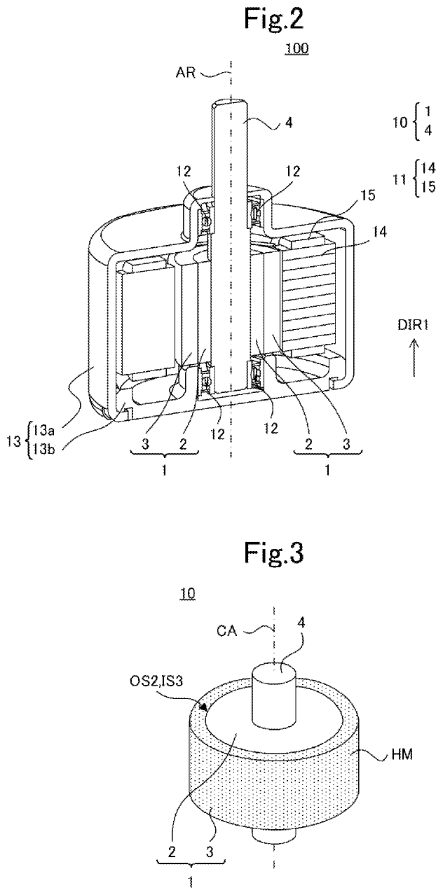

Hereinafter, a configuration of a brushless motor 100 according to a first embodiment of the present disclosure will be described with reference to the drawings. FIG. 1 is an external perspective view of the brushless motor 100 in which an integrated-yoke bonded magnet 1 is used. FIG. 2 is a schematic perspective view partially broken away to illustrate the brushless motor 100.

In the present description, as an example, directions are defined as follows. Of an axial direction along a rotation axis AR of the brushless motor 100, a direction in which a shaft 4 protrudes from an opening OP to the outside of a housing 13 is defined as a first direction DIR1.

As illustrated in FIG. 2, the brushless motor 100 includes a rotor member 10, a stator 11, a bearing 12, and the housing 13. In the present embodiment, the brushless motor 100 is of an inner rotor type. That is, the stator 11 is disposed around the rotor member 10. Note that the brushless motor 100 is an example of a rotating electrical machine of the present disclosure.

The rotor member 10 includes the integrated-yoke bonded magnet 1 and the shaft 4. In the present embodiment, the shaft 4 has a cylindrical shape extending along the first direction DIR1. Central axes of the integrated-yoke bonded magnet 1 and the shaft 4 coincide with each other, and the central axes form the rotation axis AR. Note that the shaft 4 only needs to extend along the first direction DIR1, and is not limited to a cylindrical shape, and may have a polygonal prism shape or the like. Details of the rotor member 10 and the integrated-yoke bonded magnet 1 will be described later.

The bearing 12 supports the shaft 4 so that the shaft 4 can rotate in a circumferential direction around the rotation axis AR. In the present embodiment, the number of the bearings 12 is two. Further, the bearing 12 is a ball bearing and has a cylindrical shape. A central axis of the bearing 12 coincides with a central axis of the shaft 4. Note that the number of the bearings 12 is not limited to two. Further, the bearing 12 is not limited to a ball bearing.

The stator 11 includes a magnetic core 14 and a plurality of coils 15. The magnetic core 14 is a soft magnetic material. The soft magnetic material is magnetized when a magnetic field is applied from the outside. After the above, when the application of the magnetic field is stopped, the soft magnetic material loses its magnetization.

Each of the plurality of coils 15 is made from, for example, a conductive material such as copper. Further, each of the plurality of coils 15 has a structure in which a surface of a copper wire is covered with an insulating film. Since a surface of the copper wire is covered with the insulating film, the coil 15 and the magnetic core 14 are electrically insulated. However, at two terminal end portions of the coil 15, a surface of the copper wire is not covered with the insulating film, and the copper wire is exposed.

The plurality of coils 15 are arranged in the circumferential direction around the rotation axis AR. Note that, in FIG. 2, only the representative coil 15 among the plurality of coils 15 is denoted by a reference symbol. The plurality of coils 15 are arranged in the circumferential direction around the rotation axis AR.

Each of the plurality of coils 15 is wound around the magnetic core 14. Current is supplied from a power supply (not illustrated) to each of the plurality of coils 15. Each of the plurality of coils 15 generates a magnetic field when current flows through the coil 15. The magnetic core 14 is magnetized by a magnetic field generated by the rotor member 10 and a magnetic field generated by the coil 15. Rotation of the rotor member 10 is controlled by controlling current supplied from a power supply (not illustrated).

As illustrated in FIG. 1, the housing 13 includes a first housing 13a and a second housing 13b. As illustrated in FIGS. 1 and 2, the first housing 13a has a cylindrical shape. The first housing 13a is located in the first direction DIR1 with respect to the second housing 13b. Further, the first housing 13a has the opening OP. By this, the shaft 4 protrudes from the opening OP in the first direction DIR1.

The first housing 13a supports one of the two bearings 12, the magnetic core 14, and each of the plurality of coils 15. The second housing 13b supports the other of the two bearings 12. In the present embodiment, the materials of the first housing 13a and the second housing 13b are, for example, stainless steel (SUS). Note that the material of each of the first housing 13a and the second housing 13b need only be a material having high rigidity and is not limited to SUS.

### Configuration of Rotor Member 10

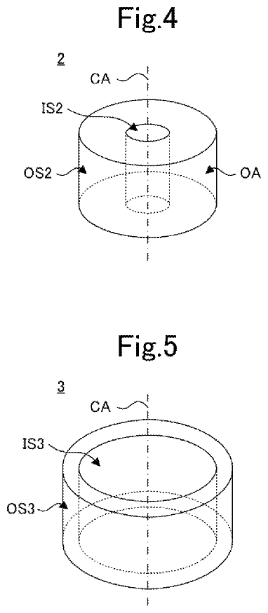

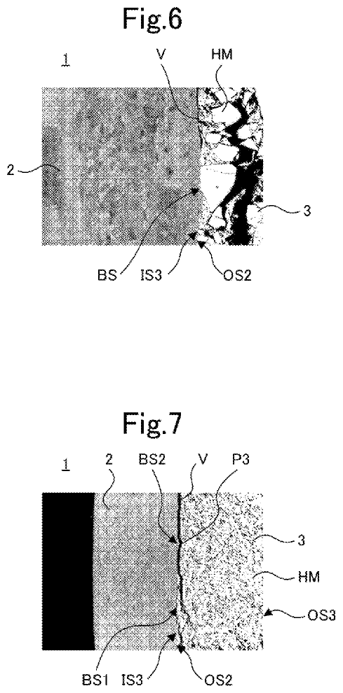

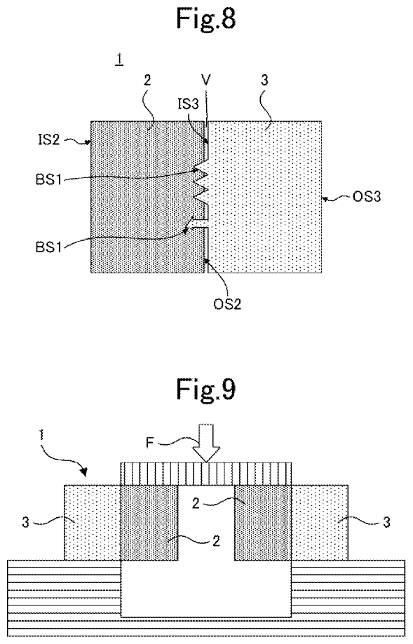

Hereinafter, a configuration of the rotor member 10 according to the first embodiment of the present disclosure will be described with reference to the drawings. FIG. 3 is a perspective view of the rotor member 10. Note that, in FIG. 3, only a representative hard magnetic material HM among the hard magnetic materials HM is denoted by a reference symbol. FIG. 4 is a perspective view of the yoke 2. FIG. 5 is a perspective view of the bonded magnet 3. FIGS. 6 and 7 are diagrams showing examples of an interface between an outer peripheral surface OS2 of the yoke 2 and an inner peripheral surface IS3 of the bonded magnet 3. Note that FIGS. 6 and 7 are examples of a photograph obtained by observing a part of the interface between the outer peripheral surface OS2 of the yoke 2 and the inner peripheral surface IS3 of the bonded magnet 3 with an electron microscope. The magnification of the electron microscope in FIG. 6 is larger than that in FIG. 7. In FIGS. 6 and 7, a portion indicated in black is a background. FIG. 8 is a schematic sectional view illustrating the interface between the outer peripheral surface OS2 of the yoke 2 and the inner peripheral surface IS3 of the bonded magnet 3.

As illustrated in FIG. 3, the integrated-yoke bonded magnet 1 includes the yoke 2 and the bonded magnet 3.

As shown in FIG. 4, in the present embodiment, the yoke 2 has a cylindrical shape. In the present embodiment, a central axis CA of the yoke 2 coincides with a central axis of the integrated-yoke bonded magnet 1 and a central axis of the shaft 4. The yoke 2 has the outer peripheral surface OS2 in a radial direction around the central axis CA and an inner peripheral surface IS2 in the radial direction around the central axis CA. The yoke 2 is attached to an outer peripheral surface of the shaft 4 such that the inner peripheral surface IS2 faces the outer peripheral surface of the shaft 4 when the integrated-yoke bonded magnet 1 is attached to the outer peripheral surface of the shaft 4. As a result, the integrated-yoke bonded magnet 1 is attached to the outer peripheral surface of the shaft 4 in the radial direction around the central axis CA. Note that the yoke 2 is not limited to a cylindrical shape, and may have a polygonal cylindrical shape, a bottomed cylindrical shape, a bottomed polygonal cylindrical shape, or the like.

The yoke 2 is a soft magnetic material. A material of the yoke 2 is, for example, stainless steel. In the present embodiment, the material of the yoke 2 is SUS430 (JIS). SUS430 (JIS) corresponds to X6Cr17 (ISO 15510).

As illustrated in FIG. 5, the bonded magnet 3 has a cylindrical shape in the present embodiment. In the present embodiment, a central axis of the bonded magnet 3 coincides with the central axis CA of the yoke 2. The bonded magnet 3 has an outer peripheral surface OS3 in the radial direction around the central axis CA, and the inner peripheral surface IS3 in the radial direction around the central axis CA. The bonded magnet 3 is disposed to face at least a partial region of the outer peripheral surface OS2 of the yoke 2. In the present embodiment, the bonded magnet 3 is joined to the yoke 2 such that the entire inner peripheral surface IS3 faces the entire outer peripheral surface OS2 of the yoke 2. Therefore, as shown in FIG. 4, in the present embodiment, the entire outer peripheral surface OS2 of the yoke 2 constitutes a facing region OA facing the bonded magnet 3. Note that the bonded magnet 3 is not limited to a cylindrical shape, and may have a polygonal cylindrical shape, a bottomed cylindrical shape, a bottomed polygonal cylindrical shape, or the like. The bonded magnet 3 need not be disposed to face the entire outer peripheral surface OS2 of the yoke 2. Therefore, the facing region OA need not be the entire outer peripheral surface OS2 of the yoke 2.

The bonded magnet 3 is a molded product of the hard magnetic material HM. Further, the bonded magnet 3 is magnetized. The hard magnetic material is magnetized when a magnetic field is applied from the outside. Thereafter, even if the application of the magnetic field is stopped, the hard magnetic material does not lose its magnetization. The hard magnetic material HM is a mixture of a rare earth-based or ferrite magnet and a binder. That is, the hard magnetic material HM includes a binder. The rare earth-based or ferrite magnet is, for example, a neodymium-based magnet, a samarium-based magnet, or a ferrite magnet, and the binder is, for example, an epoxy resin or the like. Note that the rare earth-based or ferrite magnet and the binder are not limited to the examples above.

Many actual hard magnetic materials HM are non-spherical. Therefore, a particle diameter according to the present disclosure may be, for example, a sphere equivalent diameter that is the diameter of a sphere when converted to the same volume. Further, actual shapes of the hard magnetic materials HM are irregular. Therefore, instead of extracting a single hard magnetic material HM from the bonded magnet 3 and setting a particle diameter of that single hard magnetic material HM as an average particle diameter of the hard magnetic material HM, an average particle diameter of a plurality of hard magnetic materials HM forming the bonded magnet 3 should be used as the average particle diameter of the hard magnetic material HM.

In the present embodiment, the outer peripheral surface OS2 of the yoke 2 has no visible irregularities and is smooth in appearance. The term “in appearance” according to the present disclosure means that observation is performed with the naked eye without using a device (such as an electron microscope) for observing an enlarged image of an object. More specifically, a maximum peak height of the outer peripheral surface OS2 of the yoke 2 is greater than 0 and is less than 0.5 times the average particle diameter of the hard magnetic material HM. Further, a maximum valley depth of the outer peripheral surface OS2 of the yoke 2 is greater than 0 and is less than 0.5 times the average particle diameter of the hard magnetic material HM. The “maximum peak height” according to the present disclosure means a maximum peak height Sp measured in accordance with ISO 25178. The “maximum valley depth” according to the present disclosure means a maximum valley depth Sv measured in accordance with ISO 25178.

The average particle diameter of a plurality of the hard magnetic materials HM forming the bonded magnet 3 can be measured by, for example, sieving or sectional observation. First, a measurement method by sieving will be described, and next, a measurement method by sectional observation will be described.

In the measurement by sieving, first, a plurality of sieves having different mesh openings are prepared. A plurality of the hard magnetic materials HM forming the bonded magnet 3 are put into sieves stacked in several stages in order from a sieve with a small mesh opening, and vibration is applied. After the above, a sample remaining on each sieve is weighed.

The weight of the sample remaining on each sieve is divided by the density of the plurality of hard magnetic materials HM forming the bonded magnet 3 to calculate the volume of the sample remaining on each sieve. The number of particles remaining on each sieve is calculated by dividing the volume of the sample remaining on each sieve by the volume equivalent to a sphere having the size of a mesh opening of each sieve as a diameter. By dividing the total volume of the plurality of hard magnetic materials HM forming the introduced bonded magnet 3 by the total number of particles remaining on each sieve, the average particle diameter in volume distribution of the plurality of hard magnetic materials HM forming the bonded magnet 3 can be calculated, and used as the average particle diameter of the plurality of hard magnetic materials HM forming the bonded magnet 3.

In the measurement by observing a section, first, a section of the bonded magnet 3 is exposed by polishing. The section of the bonded magnet 3 to be exposed is a section orthogonal to the radial direction around the central axis CA. Next, an observation photograph of the exposed section of the bonded magnet 3 is taken with an electron microscope. Next, from the observation photograph taken with an electron microscope, particles are detected by image analysis software “MIPAR” manufactured by MIPAR Image Analysis. After the above, the number of the detected particles and each particle area are measured. The average particle area can be calculated by dividing the sum of the particle areas by the number of the detected particles, and the average particle area can be converted into an equivalent circle diameter. The equivalent circle diameter can be used as an average particle diameter of the plurality of hard magnetic materials HM forming the bonded magnet 3. The average particle diameter of the hard magnetic material HM is about 0 to 500 μm.

As illustrated in FIG. 6, the outer peripheral surface OS2 of the yoke 2 is not smooth when viewed microscopically. Further, the inner peripheral surface IS3 of the bonded magnet 3 is not smooth when viewed microscopically. Note that, in the present description, “when viewed microscopically” means that a section is observed with a scanning electron microscope at a magnification of 1000 times.

More specifically, the outer peripheral surface OS2 of the yoke 2 has microscopic irregularities. Further, at least a part of the bonded magnet 3 interlocks with the microscopic irregularities formed on the outer peripheral surface OS2 of the yoke 2. As a result, the inner peripheral surface IS3 of the bonded magnet 3 has microscopic irregularities. The term “microscopic irregularities” according to the present disclosure means irregularities observed from an enlarged image of an object using an electron microscope or the like. Specifically, the integrated-yoke bonded magnet 1 is encapsulated with resin, and a section of a joint portion between the outer peripheral surface OS2 of the yoke 2 and the inner peripheral surface IS3 of the bonded magnet 3 is exposed by polishing. The section of the joint portion between the outer peripheral surface OS2 of the yoke 2 and the inner peripheral surface IS3 of the bonded magnet 3 to be exposed is a section orthogonal to the radial direction around the central axis CA. Next, an observation photograph of the joint portion between the outer peripheral surface OS2 of the yoke 2 and the inner peripheral surface IS3 of the bonded magnet 3 in the exposed section of the integrated-yoke bonded magnet 1 is taken at a magnification of 1000 times with a scanning electron microscope. Next, a line profile of a surface of the yoke 2 is acquired from the observation photograph taken with a scanning electron microscope. A surface roughness Ra is calculated from this line profile. Microscopic irregularities are considered present where the surface roughness Ra is 0.5 μm or more. A method of acquiring a line profile and a method of calculating the surface roughness Ra will be described.

First, an interface of the yoke 2 is extracted from the contrast of an observation photograph taken with a scanning electron microscope. Next, a center line of a line profile is drawn such that an area other than a member on the upper side of the line is equal to an area of a member on the lower side of the line. A distance between the center line of the line profile and the interface of the yoke 2 is calculated for each pixel. An average length of a vertical lines is the surface roughness Ra.

In the example illustrated in FIGS. 6 and 7, joint surfaces BS, BS1, and BS2 are formed by the outer peripheral surface OS2 of the yoke 2 and the inner peripheral surface IS3 of the bonded magnet 3. Each of the joint surfaces BS, BS1, and BS2 is a contact surface between the outer peripheral surface OS2 of the yoke 2 and the inner peripheral surface IS3 of the bonded magnet 3. On the other hand, a gap V exists between the outer peripheral surface OS2 of the yoke 2 and the inner peripheral surface IS3 of the bonded magnet 3. The outer peripheral surface OS2 of the yoke 2 and the inner peripheral surface IS3 of the bonded magnet 3 are not in contact with each other at a position where the gap V exists.

As illustrated in FIG. 7, the bonded magnet 3 is connected from the joint surface BS1 to the outer peripheral surface OS3 of the bonded magnet 3. That is, at least a part of the bonded magnet 3 is continuous from the joint surface BS1 to the outer peripheral surface OS3 of the bonded magnet 3. On the other hand, the bonded magnet 3 is not connected from the joint surface BS2 to the outer peripheral surface OS3 of the bonded magnet 3. More specifically, the gap V exists between the joint surface BS1 and the outer peripheral surface OS3 of the bonded magnet 3, and a part (P3 in FIG. 7) of the bonded magnet 3 is isolated. In the integrated-yoke bonded magnet 1, the entire bonded magnet 3 is not necessarily connected from a joint surface between the outer peripheral surface OS2 of the yoke 2 and the inner peripheral surface IS3 of the bonded magnet 3 to the outer peripheral surface OS3 of the bonded magnet 3. At least a part of the bonded magnet 3 need only be connected from the joint surface BS1 to the outer peripheral surface OS3 of the bonded magnet 3. Note that a plurality of joint surfaces BS1 may exist. That is, at least a part of the bonded magnet 3 may be connected from the plurality of joint surfaces BS1 to the outer peripheral surface OS3 of the bonded magnet 3.

Note that the wider the joint surface BS1 is, the more preferable it is. However, the joint surface BS1 may also exist only in the vicinity of an end surface of the integrated-yoke bonded magnet 1. In this case, the joint surface BS1 may exist in the vicinity of both end surfaces of the integrated-yoke bonded magnet 1, or may exist only in the vicinity of one end surface of the integrated-yoke bonded magnet 1.

Note that a bonding ratio of the joint surface BS1 can also be specifically calculated. Specifically, the integrated-yoke bonded magnet 1 is encapsulated with resin, and a section of a joint portion between the outer peripheral surface OS2 of the yoke 2 and the inner peripheral surface IS3 of the bonded magnet 3 is exposed by polishing. The section of the joint portion between the outer peripheral surface OS2 of the yoke 2 and the inner peripheral surface IS3 of the bonded magnet 3 to be exposed is a section orthogonal to the radial direction around the central axis CA. In an axial direction along the central axis CA, a bonding ratio of the joint surface BS1 can be specifically calculated from a ratio of a length of the joint surface BS1 to a length of the bonded magnet 3.

The calculated bonding ratio of the joint surface BS1 is preferably higher than 5%. Further, the calculated bonding ratio of the joint surface BS1 is more preferably 10% or more. Note that a section of the joint portion between the outer peripheral surface OS2 of the yoke 2 and the inner peripheral surface IS3 of the bonded magnet 3 is exposed a plurality of times by polishing, and it is sufficient that at least one of the joint surfaces BS1 satisfies these values.

As shown in FIG. 8, when viewed microscopically, at least a part of the inner peripheral surface IS3 of the bonded magnet 3 interlocks with the outer peripheral surface OS2 of the yoke 2, so that a part of the interface between the outer peripheral surface OS2 of the yoke 2 and the inner peripheral surface IS3 of the bonded magnet 3 has a wedge shape or an anchor shape.

In the integrated-yoke bonded magnet 1, a part of the bonded magnet 3 interlocks with microscopic irregularities formed on the outer peripheral surface OS2 of the yoke 2, so that the yoke 2 and the bonded magnet 3 are joined even if a protrusion and a plurality of notches are not provided on the outer peripheral surface OS2 of the yoke 2. As a result, the integrated-yoke bonded magnet 1 in which the yoke 2 and the bonded magnet 3 are joined can be obtained without providing a step of forming a protrusion and a plurality of notches on the outer peripheral surface OS2 of the yoke 2, and a manufacturing process of the integrated-yoke bonded magnet can be simplified.

In the integrated-yoke bonded magnet 1, at least a part of the bonded magnet 3 is connected from the joint surface BS1 to the outer peripheral surface OS3 of the bonded magnet 3. As a result, the yoke 2 more firmly supports the bonded magnet 3 from the inner peripheral surface IS3 to the outer peripheral surface OS3. Therefore, the yoke 2 and the bonded magnet 3 are more firmly joined.

In the integrated-yoke bonded magnet 1, there may be a plurality of joint surfaces BS1. That is, at least a part of the bonded magnet 3 may be connected from the plurality of joint surfaces BS1 to the outer peripheral surface OS3 of the bonded magnet 3. As a result, the yoke 2 more firmly supports the bonded magnet 3 from the inner peripheral surface IS3 to the outer peripheral surface OS3. Therefore, the yoke 2 and the bonded magnet 3 are more firmly joined.

In the integrated-yoke bonded magnet 1, a maximum peak height of the outer peripheral surface OS2 of the yoke 2 is greater than 0 and is less than 0.5 times the average particle diameter of the hard magnetic material HM. Further, a maximum valley depth of the outer peripheral surface OS2 of the yoke 2 is greater than 0 and is less than 0.5 times the average particle diameter of the hard magnetic material HM. That is, the yoke 2 and the bonded magnet 3 are joined to each other even if the outer peripheral surface OS2 of the yoke 2 is not limited to having a protrusion and has no grooves.

In the integrated-yoke bonded magnet 1, the hard magnetic material HM includes a binder. As a result, the rare earth-based or ferrite magnets more firmly adhere to each other during molding of the hard magnetic material HM, and the strength of the hard magnetic material HM is improved. Consequently, the strength of the bonded magnet 3 is improved, and the strength of the integrated-yoke bonded magnet 1 is improved.

The inventor conducted an experiment to measure the bonding strength between the outer peripheral surface OS2 of the yoke 2 and the inner peripheral surface IS3 of the bonded magnet 3. FIG. 9 is a schematic sectional view illustrating an experiment for measuring bonding strength between the outer peripheral surface OS2 of the yoke 2 and the inner peripheral surface IS3 of the bonded magnet 3. In this experiment, as shown in FIG. 9, by supporting an end surface of the bonded magnet 3 and gradually increasing a load F applied to an end surface of the yoke 2, a load F1 was measured when the yoke 2 was removed or the bonded magnet 3 fractured. Then, the load F1/(outer peripheral length of the yoke 2×height of the integrated-yoke bonded magnet 1) was defined as breaking strength. Note that the outer peripheral length of the yoke 2 is the length of the outer peripheral surface OS2 of the yoke 2 in a circumferential direction around the central axis CA of the yoke 2. The height of the integrated-yoke bonded magnet 1 is the length of the integrated-yoke bonded magnet 1 in the axial direction along the central axis CA of the yoke 2. It can be said that the larger the breaking strength, the stronger the bond between the outer peripheral surface OS2 of the yoke 2 and the inner peripheral surface IS3 of the bonded magnet 3. The inventor conducted the experiment for a case where the material of the yoke 2 was SUS430 and a case where the material of the yoke 2 was carbon steel.

In the case where the material of the yoke 2 was SUS 430, the breaking strength was 1.3 MPa. Further, in the case where the material of the yoke 2 was carbon steel, the breaking strength was 0.5 MPa. It has been confirmed that even if the outer peripheral surface OS2 of the yoke 2 does not have a protrusion and a plurality of notches, a part of the bonded magnet 3 interlocks with microscopic irregularities formed on the outer peripheral surface OS2 of the yoke 2, so that the yoke 2 and the bonded magnet 3 are joined.

In this experiment, the breaking strength is higher in the case where the material of the yoke 2 is SUS430 than in the case where the material of the yoke 2 is carbon steel. Further, in this experiment, it was confirmed that the breaking strength was higher in the case where the material of the yoke 2 was SUS430 than in the case where the material of the yoke 2 was carbon steel, not only for loads applied along the axial direction but also for loads applied along the circumferential direction around the central axis CA of the yoke 2. Therefore, when the material of the yoke 2 is stainless steel, the outer peripheral surface OS2 of the yoke 2 and the inner peripheral surface IS3 of the bonded magnet 3 are more firmly joined. As a result, the yoke 2 and the bonded magnet 3 are more firmly joined.

In the integrated-yoke bonded magnet 1, at least a part of the bonded magnet 3 is connected from the joint surface BS1 between the outer peripheral surface OS2 of the yoke 2 and the inner peripheral surface IS3 of the bonded magnet 3 to the outer peripheral surface OS3 of the bonded magnet 3, so that the outer peripheral surface OS3 of the bonded magnet 3 is supported by the yoke 2. By this, the yoke 2 and the bonded magnet 3 are more firmly joined.

In the integrated-yoke bonded magnet 1, a maximum peak height of the outer peripheral surface OS2 of the yoke 2 is greater than 0 and is less than 0.5 times the average particle diameter of the hard magnetic material HM. Further, a maximum valley depth of the outer peripheral surface OS2 of the yoke 2 is greater than 0 and is less than 0.5 times the average particle diameter of the hard magnetic material HM. That is, the yoke 2 and the bonded magnet 3 are joined to each other even if the outer peripheral surface OS2 of the yoke 2 is not limited to having a protrusion and has no grooves.

In the integrated-yoke bonded magnet 1, the hard magnetic material HM includes a binder. As a result, the rare earth-based or ferrite magnets more firmly adhere to each other during molding of the hard magnetic material HM, and the strength of the hard magnetic material HM is improved. Consequently, the strength of the bonded magnet 3 is improved, and the strength of the integrated-yoke bonded magnet 1 is improved.

### Method of Manufacturing Integrated-Yoke Bonded Magnet 1)

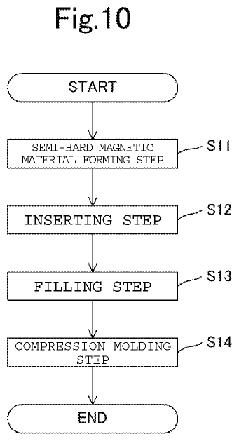

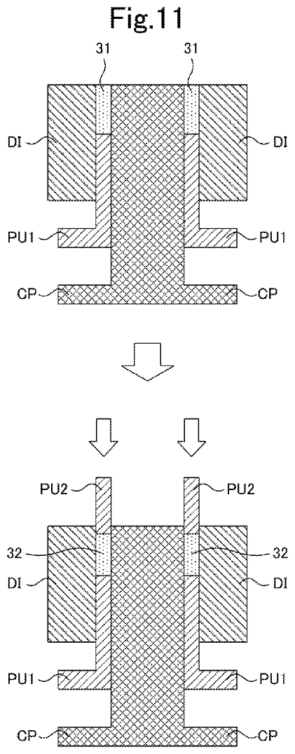

Hereinafter, a method of manufacturing the integrated-yoke bonded magnet 1 according to the first embodiment of the present disclosure will be described with reference to the drawings. FIG. 10 is a flowchart illustrating an example of the method of manufacturing the integrated-yoke bonded magnet 1. FIGS. 11 to 14 are sectional views each illustrating an example of a manufacturing process of the integrated-yoke bonded magnet 1.

As illustrated in FIGS. 10 and 11, first, hard magnetic powder 31 is compression-molded to form a cylindrical semi-hard magnetic material 32 (FIG. 10: Step S11, semi-hard magnetic material forming step). The hard magnetic powder 31 is a mixture of rare earth-based or ferrite magnet powder and binder powder. The rare earth-based or ferrite magnet powder is, for example, neodymium-based magnet powder, samarium-based magnet powder, ferrite magnet powder, or the like, and the binder powder is, for example, epoxy resin powder or the like. Note that the rare earth-based or ferrite magnet powder and the binder powder are not limited to the examples above. For example, the hard magnetic powder 31 is injected into a cylindrical mold DI into which a cylindrical core pin CP is inserted, and then the hard magnetic powder 31 is pressurized at a pressure of 100 to 1000 MPa by cylindrical punches PU1 and PU2, and the hard magnetic powder 31 is compression-molded, so that the cylindrical semi-hard magnetic material 32 can be obtained. At this time, an inner peripheral surface IS32 of the semi-hard magnetic material 32 has microscopic irregularities and is not smooth.

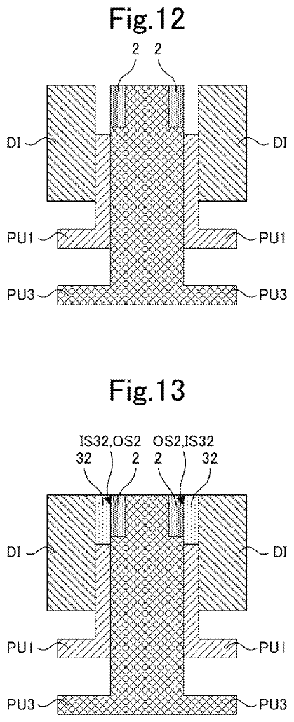

Next, as shown in FIGS. 10 and 12, the yoke 2 is inserted into the mold DI (FIG. 10: Step S12, inserting step). For example, the yoke 2 is inserted into the mold DI into which a cylindrical punch PU3 is inserted. A diameter of the punch PU3 is slightly shorter than inner diameters of the punches PU1 and PU2.

Next, as shown in FIGS. 10 and 13, after the semi-hard magnetic material forming step and the inserting step, the mold DI is filled with the semi-hard magnetic material 32 such that the outer peripheral surface OS2 of the yoke 2 and the inner peripheral surface IS32 of the semi-hard magnetic material 32 face each other (FIG. 10: Step S13, filling step). For example, the cylindrical mold DI into which the punch PU1 is inserted is filled with the semi-hard magnetic material 32 such that the outer peripheral surface OS2 of the yoke 2 and the inner peripheral surface IS32 of the semi-hard magnetic material 32 face each other.

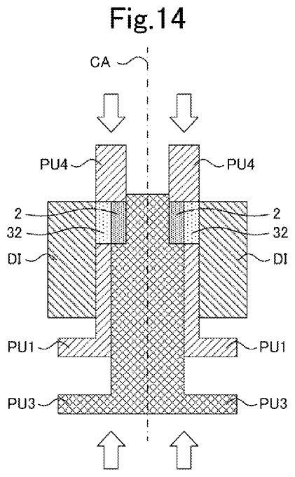

Next, as shown in FIGS. 10 and 14, after the filling step, the yoke 2 and the semi-hard magnetic material 32 are compression-molded along an axial direction along the central axis CA of the yoke 2 (FIG. 10: Step S14, compression molding step). Although the yoke 2 and the semi-hard magnetic material 32 are reduced in size in the axial direction by the compression molding, the amount of reduction in size of the yoke 2 is extremely small. For example, in a case where the yoke 2 is inserted on the punch PU3 in the inserting step and filling with the semi-hard magnetic material 32 is performed on the punch PU1 in the filling step, the yoke 2 and the semi-hard magnetic material 32 are pressurized at a pressure of 500 to 2000 MPa while sandwiched between the punches PU1 and PU3 and a cylindrical punch PU4 in the axial direction, and the yoke 2 and the semi-hard magnetic material 32 are compression-molded. As a result, when viewed microscopically, the inner peripheral surface IS3 of the bonded magnet 3 interlocks with the outer peripheral surface OS2 of the yoke 2, and the integrated-yoke bonded magnet 1 in which the bonded magnet 3 is joined to the yoke 2 can be obtained.

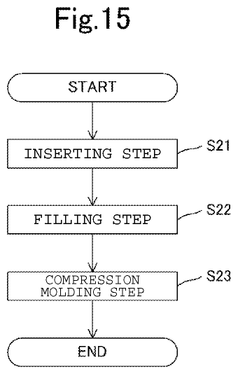

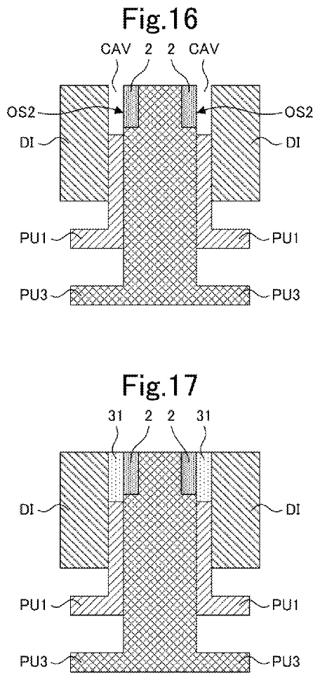

Note that the integrated-yoke bonded magnet 1 according to the first embodiment of the present disclosure can also be manufactured by the following manufacturing method. FIG. 15 is a flowchart illustrating an example of a method of manufacturing the integrated-yoke bonded magnet 1. FIGS. 16 to 18 are sectional views each illustrating an example of a manufacturing process of the integrated-yoke bonded magnet 1.

As shown in FIGS. 15 and 16, the yoke 2 is inserted into the mold DI (FIG. 15: Step S21, inserting step). For example, the yoke 2 is inserted into the mold DI into which the punch PU3 is inserted. Since an outer diameter of the yoke 2 is shorter than an inner diameter of the mold DI, a cavity CAV is formed between the outer peripheral surface OS2 of the yoke 2 and an inner peripheral surface of the mold DI.

Next, as illustrated in FIGS. 15 and 17, after the inserting step, the cavity CAV is filled with the hard magnetic powder 31 (FIG. 15: Step S22, filling step).

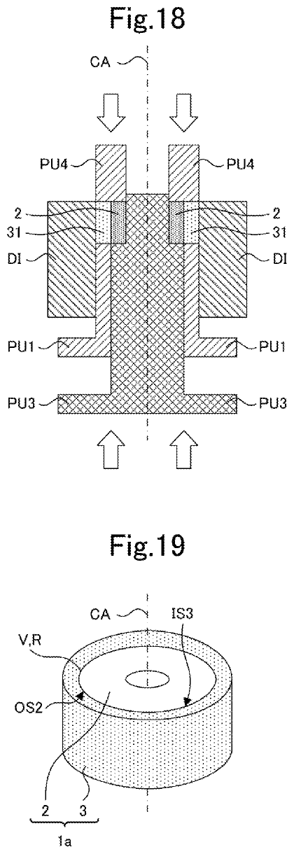

Next, as shown in FIGS. 15 and 18, after the filling step, the yoke 2 and the hard magnetic powder 31 are compression-molded along an axial direction along the central axis CA of the yoke 2 (FIG. 15: Step S23, compression molding step). For example, in a case where the yoke 2 is inserted on the punch PU3 in the inserting step and filling with the hard magnetic powder 31 is performed on the punch PU1 in the filling step, the yoke 2 and the hard magnetic powder 31 are pressurized at a pressure of 500 to 2000 MPa while sandwiched between the punches PU1 and PU3 and the cylindrical punch PU4 in the axial direction, and the yoke 2 and the hard magnetic powder 31 are compression-molded. As a result, when viewed microscopically, the inner peripheral surface IS3 of the bonded magnet 3 interlocks with the outer peripheral surface OS2 of the yoke 2, and the integrated-yoke bonded magnet 1 in which the bonded magnet 3 is joined to the yoke 2 can be obtained.

According to the method of manufacturing the integrated-yoke bonded magnet 1, the integrated-yoke bonded magnet 1 can be easily manufactured without complicating the manufacturing process. More specifically, even if a step of forming a protrusion and a plurality of notches in the outer peripheral surface OS2 of the yoke 2 is not provided, by compression-molding the yoke 2 and the semi-hard magnetic material 32 along the axial direction along the central axis CA of the yoke 2, the inner peripheral surface IS3 of the bonded magnet 3 interlocks with the outer peripheral surface OS2 of the yoke 2 when viewed microscopically. As a result, the integrated-yoke bonded magnet 1 in which the bonded magnet 3 is joined to the yoke 2 can be manufactured.

### First Modification

### Configuration of Integrated-Yoke Bonded Magnet 1a

Hereinafter, a configuration of an integrated-yoke bonded magnet 1a according to a first modification of the present disclosure will be described with reference to the drawings. FIG. 19 is a perspective view of the integrated-yoke bonded magnet 1a. For the integrated-yoke bonded magnet 1a according to the first modification, only a part different from the integrated-yoke bonded magnet 1 according to the first embodiment will be described, and the remaining part will be omitted.

As illustrated in FIG. 19, the integrated-yoke bonded magnet 1a is different from the integrated-yoke bonded magnet 1 in including resin R entering the gap V between the outer peripheral surface OS2 of the yoke 2 and the inner peripheral surface IS3 of the bonded magnet 3.

The integrated-yoke bonded magnet 1a described above also has the same effect as the integrated-yoke bonded magnet 1. Further, according to the integrated-yoke bonded magnet 1a, the resin R entering the gap V between the outer peripheral surface OS2 of the yoke 2 and the inner peripheral surface IS3 of the bonded magnet 3 bonds the outer peripheral surface OS2 of the yoke 2 to the inner peripheral surface IS3 of the bonded magnet 3, so that the outer peripheral surface OS2 of the yoke 2 and the inner peripheral surface IS3 of the bonded magnet 3 are more firmly joined together. Therefore, the yoke 2 and the bonded magnet 3 are more firmly joined.

### Method of Manufacturing Integrated-Yoke Bonded Magnet 1a

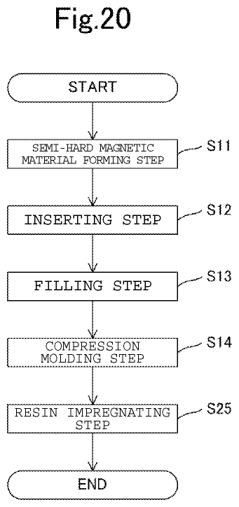

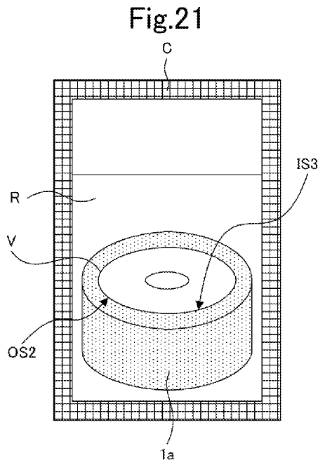

Hereinafter, a method of manufacturing the integrated-yoke bonded magnet 1a according to the first modification of the present disclosure will be described with reference to the drawings. FIG. 20 is a flowchart illustrating an example of the method of manufacturing the integrated-yoke bonded magnet 1a. FIG. 21 is a sectional view illustrating an example of the method of manufacturing the integrated-yoke bonded magnet 1a. Note that, for the method of manufacturing the integrated-yoke bonded magnet 1a according to the first modification, only a part different from the method of manufacturing the integrated-yoke bonded magnet 1 according to the first embodiment will be described, and the remaining part will be omitted.

As shown in FIG. 20, the method of manufacturing the integrated-yoke bonded magnet 1a is different from the method of manufacturing the integrated-yoke bonded magnet 1 in including a resin impregnating step.

In the method of manufacturing the integrated-yoke bonded magnet 1a, as shown in FIGS. 20 and 21, after the compression molding step, the resin R is caused to enter the gap V between the outer peripheral surface OS2 of the yoke 2 and the inner peripheral surface IS3 of the bonded magnet 3 (FIG. 20: Step S25, resin impregnating step). For example, the integrated-yoke bonded magnet 1 is disposed in a container C. Thereafter, the resin R is injected into the container C, and the integrated-yoke bonded magnet 1 is immersed in the resin R, so that the resin R is caused to enter the gap V between the outer peripheral surface OS2 of the yoke 2 and the inner peripheral surface IS3 of the bonded magnet 3, and the integrated-yoke bonded magnet 1a can be obtained. Alternatively, by injecting the resin R into the gap V between the outer peripheral surface OS2 of the yoke 2 and the inner peripheral surface IS3 of the bonded magnet 3, the resin R may be caused to enter the gap V between the outer peripheral surface OS2 of the yoke 2 and the inner peripheral surface IS3 of the bonded magnet 3 to obtain the integrated-yoke bonded magnet 1a.

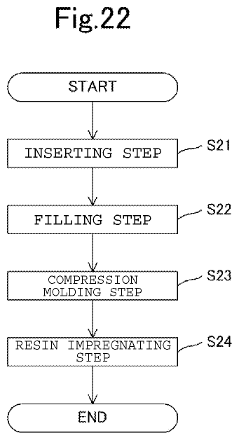

Note that the integrated-yoke bonded magnet 1a according to the first modification of the present disclosure can also be manufactured by the following manufacturing method. FIG. 22 is a flowchart illustrating an example of the method of manufacturing the integrated-yoke bonded magnet 1a. As shown in FIG. 22, after the compression molding step, the resin R is caused to enter the gap V between the outer peripheral surface OS2 of the yoke 2 and the inner peripheral surface IS3 of the bonded magnet 3 (FIG. 22: Step S24, resin impregnating step).

According to the method of manufacturing the integrated-yoke bonded magnet 1a, the integrated-yoke bonded magnet 1a can be easily manufactured without complicating the manufacturing process.

### Other Embodiments

The integrated-yoke bonded magnet according to the present disclosure is not limited to the integrated-yoke bonded magnet 1 and the integrated-yoke bonded magnet 1a, and can be modified within the scope of the gist of the present disclosure. Further, the configurations of the integrated-yoke bonded magnet 1 or the integrated-yoke bonded magnet 1a may be arbitrarily combined. Further, the method of manufacturing the integrated-yoke bonded magnet according to the present disclosure is not limited to the method of manufacturing the integrated-yoke bonded magnet 1 and the method of manufacturing the integrated-yoke bonded magnet 1a, and can be modified within the scope of the gist of the present disclosure. Further, the method of manufacturing the integrated-yoke bonded magnet 1 or the method of manufacturing the integrated-yoke bonded magnet 1a may be arbitrarily combined.

Note that the rotating electrical machine according to the present disclosure only needs to include the integrated-yoke bonded magnet 1 or the integrated-yoke bonded magnet 1a, and may include a brush. Further, the rotating electrical machine according to the present disclosure may be of an outer rotor type. That is, the rotor member 10 may be disposed around the stator 11.

Note that the rotating electrical machine according to the present disclosure may have a structure in which a rotor rotates by electricity. Alternatively, the rotating electrical machine according to the present disclosure may have a structure in which electricity is generated by rotation of a rotor. The rotating electrical machine according to the present disclosure includes a brushless motor, a permanent magnet synchronous motor, a permanent magnet synchronous generator, or the like.

### DESCRIPTION OF REFERENCE SYMBOLS

1, 1a: Integrated-yoke bonded magnet
2: Yoke
3: Bonded magnet
4: Shaft
10: Rotor member
11: Stator
12: Bearing
13: Housing
13a: First housing
13b: Second housing
14: Magnetic core
15: Coil
31: Hard magnetic powder
32: Semi-hard magnetic material
100: Brushless motor
AR: Rotation axis
BS, BS1, BS2: Joint surface
C: Container
CA: Central axis
CAV: Cavity
CP: Core pin
DI: Mold
DIR1: First direction
HM: Hard magnetic material
IS2, IS3, IS32: Inner peripheral surface
OP: Opening
OS2, OS3: Outer peripheral surface
PU1 to PU4: Punch
V: Gap

1. An integrated-yoke bonded magnet comprising:
a yoke having an outer peripheral surface; and
a bonded magnet comprising a molded hard magnetic material disposed radially outward of the yoke, the bonded magnet having an inner peripheral surface facing at least a portion of the outer peripheral surface of the yoke, wherein
the outer peripheral surface of the yoke is smooth in appearance and includes microscopic irregularities in at least a facing region that faces the bonded magnet, and
the inner peripheral surface of the bonded magnet includes microscopic irregularities formed by a portion of the bonded magnet interlocking with the microscopic irregularities of the outer peripheral surface of the yoke.

2. The integrated-yoke bonded magnet according to claim 1, wherein at least a portion of the bonded magnet extends continuously from a joint surface between the outer peripheral surface of the yoke and the inner peripheral surface of the bonded magnet to an outer peripheral surface of the bonded magnet.

3. The integrated-yoke bonded magnet according to claim 2, wherein a plurality of joint surfaces are provided between the outer peripheral surface of the yoke and the inner peripheral surface of the bonded magnet.

4. The integrated-yoke bonded magnet according to claim 1, wherein:
a maximum peak height of the outer peripheral surface of the yoke is greater than 0 and less than 0.5 times an average particle diameter of the hard magnetic material; and
a maximum valley depth of the outer peripheral surface of the yoke is greater than 0 and less than 0.5 times the average particle diameter of the hard magnetic material.

5. The integrated-yoke bonded magnet according to claim 1, wherein the hard magnetic material comprises a binder.

6. The integrated-yoke bonded magnet according to claim 5, wherein the binder comprises an epoxy resin.

7. The integrated-yoke bonded magnet according to claim 1, further comprising a resin in a gap between the outer peripheral surface of the yoke and the inner peripheral surface of the bonded magnet.

8. The integrated-yoke bonded magnet according to claim 1, wherein the yoke comprises stainless steel.

9. The integrated-yoke bonded magnet according to claim 1, wherein the hard magnetic material comprises a rare earth-based magnet material or a ferrite magnet material.

10. The integrated-yoke bonded magnet according to claim 9, wherein the rare earth-based magnet material comprises at least one of a neodymium-based magnet or a samarium-based magnet.

11. The integrated-yoke bonded magnet according to claim 1, wherein the yoke has a cylindrical shape.

12. The integrated-yoke bonded magnet according to claim 1, wherein the bonded magnet has a cylindrical shape and a central axis of the bonded magnet coincides with a central axis of the yoke.

13. A rotor member comprising:
the integrated-yoke bonded magnet according to claim 12; and
a shaft extending along an axial direction of the central axis of the yoke, wherein the yoke is attached to an outer peripheral surface of the shaft.

14. A rotating electrical machine comprising:
an integrated-yoke bonded magnet according to claim 1.

15. A method of manufacturing an integrated-yoke bonded magnet, the method comprising:
compression-molding hard magnetic powder to form a cylindrical semi-hard magnetic material;
inserting a cylindrical yoke in a mold;
filling the mold with the semi-hard magnetic material such that an outer peripheral surface of the yoke and an inner peripheral surface of the semi-hard magnetic material face each other; and
compression-molding the yoke and the semi-hard magnetic material along an axial direction along a central axis of the yoke to form a bonded magnet having an inner peripheral surface with microscopic irregularities interlocking with microscopic irregularities of the outer peripheral surface of the yoke.

16. The method of manufacturing the integrated-yoke bonded magnet according to claim 15, further comprising:
causing resin to enter a gap between the outer peripheral surface of the yoke and the inner peripheral surface of the semi-hard magnetic material.

17. A method of manufacturing an integrated-yoke bonded magnet, the method comprising:
inserting a cylindrical yoke in a mold, the yoke having an outer peripheral surface that is smooth in appearance and includes microscopic irregularities;
filling a cavity between an outer peripheral surface of the yoke and an inner peripheral surface of the mold with a hard magnetic material; and
compression-molding the yoke and the hard magnetic material along an axial direction of a central axis of the yoke to form a bonded magnet having an inner peripheral surface with microscopic irregularities interlocking with the microscopic irregularities of the outer peripheral surface of the yoke.

18. The method of manufacturing the integrated-yoke bonded magnet according to claim 17, wherein the hard magnetic material comprises hard magnetic powder comprising a mixture of rare earth-based or ferrite magnet powder and binder powder.

19. The method of manufacturing the integrated-yoke bonded magnet according to claim 17, further comprising:
causing a resin to enter a gap between the outer peripheral surface of the yoke and the inner peripheral surface of the bonded magnet.

20. The method of claim 17, wherein the compression molding is performed at a pressure of 500 to 2000 MPa.
